(19) United States
(12) Patent Application Publication
(10) Pub. No.: US 2007/0211152 A1
(43) Pub. Date: Sep. 13, 2007

(54) Digital camera

(75) Inventor: Sumio Sakai, Osato-gun (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/517,448

(22) Filed: Sep. 8, 2006

(30) Foreign Application Priority Data
Sep. 16, 2005 (JP) 2005-270759

(51) Int. Cl. H04N 5/76

(52) U.S. Cl. 348/231.3

(57) ABSTRACT

According to one embodiment, a medium controller controls communication between one, which is selected, of an HDD and an SD card and an MPEG Coder. A switch selects one of the HDD and the SD card, and connects the selected recording medium to the medium controller. A DSP controls connection of the switch according to an instruction input through a user interface.

### CROSS-REFERENCE TO RELATED APPLICATIONS

This application is based upon and claims the benefit of priority from Japanese Patent Application No. 2005-270759, filed Sep. 16, 2005, the entire contents of which are incorporated herein by reference.

### BACKGROUND

1. Field

One embodiment of the invention relates to a digital camera which compresses image data obtained by image picking up operation, and records it into a recording medium.

2. Description of the Related Art

A digital camera allows a portable recording medium such as a memory card containing a semiconductor memory to be attached thereto. Images picked up may be stored into the memory card. Image data stored is read out from the memory card through an operation by a user, and is displayed on a liquid crystal display (LCD) unit equipped to the camera.

Recently, a digital camera equipped with a hard disk drive (HDD) as a large-capacity recording medium was developed. In such a camera, the number of still pictures and a time length of motion pictures that can be recorded are much increased when compared to a conventional digital camera.

Generally, in the digital camera, an optical image formed through the lens is transformed into an electrical signal by the CCD, and then the electrical signal is converted into a digital signal by an A/D converter. The signal from the A/D converter is converted into a video signal having a predetermined format by a DSP, and then compressed by a compression/decompression unit. A digital camera equipped with the memory card and the HDD generally includes a first interface circuit for the memory card and a second interface circuit for the HDD, both forming a communication control unit for interfacing with the medium. An image data compressed by the compression/decompression unit is output to the first and second interface circuits. When the compressed data is transferred from the compression/decompression unit to the memory card, the first interface circuit operates, and when it is transferred to the HDD, the second interface circuit operates.

When a data written into the medium is played back, the operation is performed through the reverse path. Specifically, in playing back compressed data written into the memory card, the first interface circuit operates. In playing back the compressed data written into the HDD, the second interface circuit operates. The compression/decompression unit decompresses the input compressed data, and the decompressed data is displayed on an LCD through an LCD controller.

Jpn. Pat. Appln. KOKAI Publication No. 2004-187057 discloses a following digital camera. The digital camera has an internal memory, a micro drive (HDD) and a memory card. When a zooming and an AF mechanism are driven during recording of motion pictures, control prohibits to drive a micro drive, and records the data in the internal memory or the memory card thereby to restrict excess current and hence, to prevent the system down.

The digital camera is portably used. Accordingly, the size reduction is an important subject in the digital camera. Cost reduction is required for the digital camera as well as other products. A possible way to reduce the size and cost of the device is to reduce the number of devices of the electronic circuit components, for example, LSIs contained in the device. The interface circuits may be fabricated as one integrated circuit. When a plurality of recording media, for example, an HDD and a memory card, are used, the interface circuits are respectively required for those media, as described above.

The Jpn. Pat. Appln. KOKAI Publication No. 2004-187057 discloses a circuit configuration in which the micro drive and the memory card are connected to one interface circuit, and the compression/decompression unit transfers data to and from one of the micro drive and the memory card through the interface circuit. However, in the patent document, there is no description of a circuit configuration of the interface circuit per se, and no indication of reduction of the number of the interface circuit components used.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing a configuration of a digital camera according to an embodiment of the present invention;

FIG. 2 is a diagram showing wiring of main signal lines of a medium controller 5, a switch 14, an SD card 6, and an HDD 8; and

FIG. 3 is a flow chart showing an embodiment of a dubbing process carried out by the digital camera of the invention.

### DETAILED DESCRIPTION

Various embodiments according to the invention will be described hereinafter with reference to the accompanying drawings. In general, according to one embodiment of the invention, there is provided a digital camera comprising: an image pickup unit which picks up an optical image; a compression unit which compresses an image data picked up by the image pickup unit; a first recording medium which stores the data compressed by the compression unit; a second recording medium which stores the data compressed by the compression unit; a communication controller which controls communication between one, which is selected, of the first recording medium and the second recording medium, and the compression unit; a connection selector unit which selects one of the first recording medium and the second recording medium, and connects the selected recording medium to the communication controller; a user interface; and a control unit which controls the connection of the connection selector unit according to an instruction input through the user interface.

Accordingly, one embodiment of the present invention reduces the number of interface circuit components applied to a plurality of recording media, and reduces the size and the cost of a digital camera.

An embodiment of the present invention will be described with reference to the accompanying drawings.

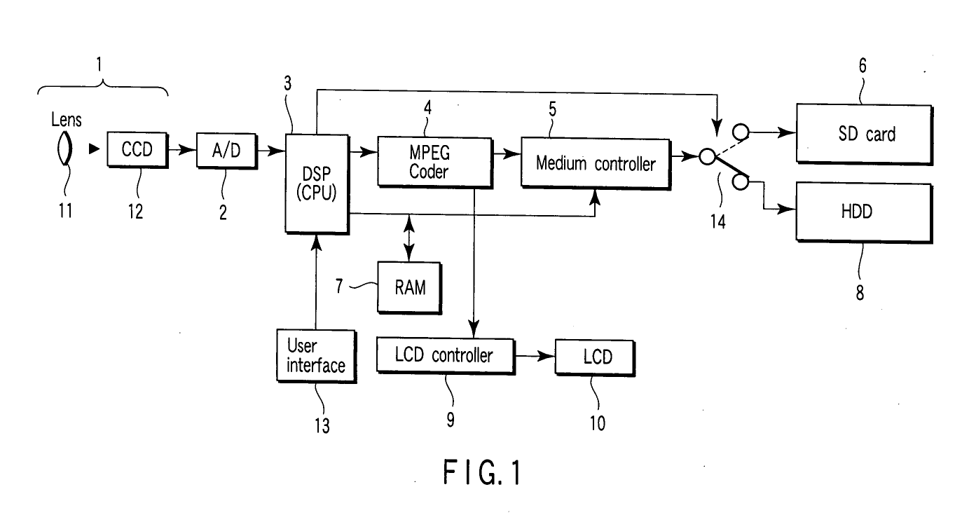

FIG. 1 is a block diagram showing a configuration of a digital camera according to an embodiment of the present invention.

An optical image formed through an imaging lens 11 is transformed into an electrical signal by a CCD 12, and converted into a digital signal by an AD converter 2. The imaging lens 11 and the CCD 12 form an image pickup unit 1 for picking up an optical image. A signal output from the AD converter 2 is converted into an image data (including still picture data and motion picture data) of a predetermined format, for example, RGB by a DSP (digital signal processor) 3. The DSP 3 serves also as a CPU (central processing unit) for overall controlling the present device. The DSP 3 contains various kinds of control programs, and controls each of units of the device while using a RAM 7 as a work area, according to a user instruction input through a user interface (UIF) 13.

The image data from the DSP 3 is compressed by the MPEG Coder 4. The compressed image data is output through a medium controller 5 and a switch 14 to an SD (secured digital) card 6 or an HDD 8, and recorded therein under control of the medium controller 5. The medium controller 5 is a communication controller unit for interfacing with the MPEG Coder 4 and the recording medium (the SD card 6 or the HDD 8).

The switch (connection selecting unit) 14 is an analog switch for transferring the image data supplied from the medium controller 5 to one of the SD card 6 or the HDD 8 according to a control signal from the DSP 3. The SD card 6 is a memory card having a 2 Gbytes capacity for example. The HDD 8 is a recording medium having a 20 Gbytes capacity for example and is contained in the device.

When the image data is played back from the recording medium, the SD card 6 or the HDD 8 is selected by using the switch 14, and the image data from the selected medium is read out under control of the media controller 5. The image data (compressed data) read out is decompressed by the MPEG Coder 4, and displayed on a liquid crystal display (LCD) unit 10 under control of an LCD controller 19.

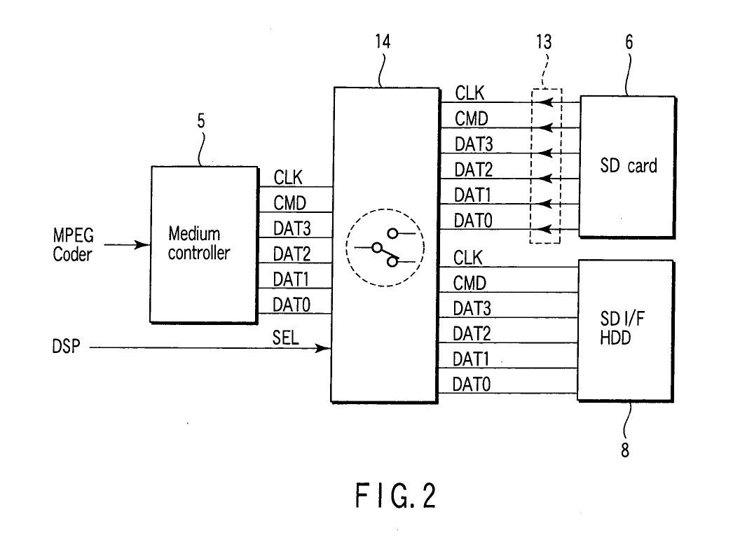

FIG. 2 is a diagram showing wiring of main signal lines of the medium controller 5, the switch 14, the SD card 6, and the HDD 8. In the description to be given hereunder, the same reference symbols will be used for designating signal lines and signals.

The medium controller 5 transmits data and commands in parallel in synchronism with clock signals CLK, through a 4-bit bus line DAT 0 to DAT 3. To transmit the data, a signal CMD is set at low level, for example, and to transmit the command, it is set at high level. In data recording mode, the medium controller 5 converts the format of the image data compressed with MPEG method, which is supplied from the MPEG Coder 4, into the data format of the SD card 6, and sends the formatted data to the switch 14 via bus lines DAT 0 to DAT 3. The medium controller 5 carries out a process to absorb processing speed difference between the DSP 3, and the SD card 6 and the HDD 8 by using a buffer memory contained therein.

The switch 14 connects signal lines CLK, CMD and DAT 0 to DAT 3 derived from the medium controller 5 to signal lines CLK, CMD and DAT 0 to DAT 3 of one of the SD card 6 and the HDD 8, according to a select signal SEL supplied from the DSP 3. The SD card 6 is a recording medium, removably attached, for recording data of the SD card format, and is connected to the switch 14 through a card slot 15. The HDD 8 is an HDD for an SD interface, which is able to transfer data in the same interface method as of the SD card, and into which data of the SD card format is recorded. Therefore, the medium controller 5 is capable of performing data communication irrespective of the type of the recording medium.

Next, a dubbing process for copying an image data recorded in one medium into another medium will be described.

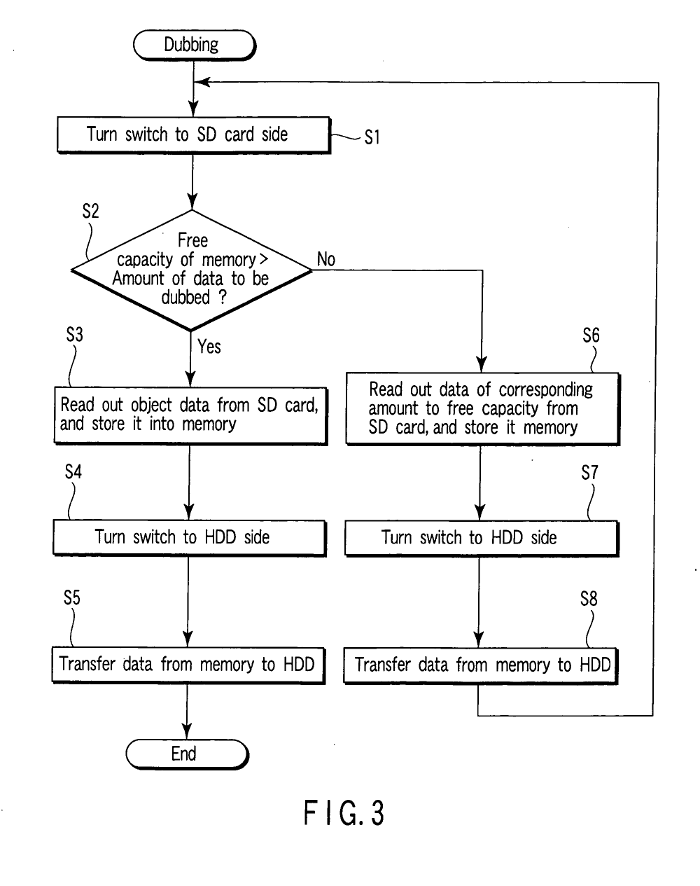

FIG. 3 is a flow chart showing an embodiment of a dubbing process carried out by the digital camera of the invention. Description will be given using a case where an image data recorded in the SD card 6 is dubbed into the HDD 8.

When a dubbing instruction is input through the user interface 13, the DSP 3 turns the switch (SW) 14 to the SD card side (S1), and determines whether or not a free capacity of the RAM 7 is larger than the amount of data to be dubbed (S2). When the free capacity is larger than the amount of data to be dubbed, the DSP 3 reads out the image data to be dubbed from the SD card by using the medium controller 5, and stores the read out image data into the RAM 7 (S3). Then, the DSP 3 turns the switch 14 to the HDD 8 side (S4), and transfers the dubbed data from the RAM 7 to the HDD 8 (S5), and the process ends.

When the free capacity is smaller than the amount of data to be dubbed (No at S2), the DSP 3 reads out image data to be dubbed of corresponding amount to the free capacity from the SD card 6, and stores the read out data into the memory (S6). Then, the DSP 3 turns the switch 14 to the HDD side (S7), and transfers the dubbed data from the memory to the HDD 8 (S8).

The process returns to the step S1, and the DSP 3 executes the steps S1 and S2 again. The DSP 3 executes the steps S6 to S8, and the steps S1 and S2 till the free capacity of the RAM 7 exceeds the amount of the data to be dubbed and left in the SD card 6.

When the free capacity of the RAM 7 exceeds the amount of the data to be dubbed and left in the SD card 6 (Yes at S2), the DSP 3 executes the steps S3 to S5, the process ends.

As described above, while conventionally a plurality of medium controllers are needed to communicate with a plurality of media, the present invention enables one medium controller to communicate with a plurality of media by using the switch. Accordingly, the invention reduces the number of necessary medium controllers, and reduces the cost to manufacture and a substrate area on which the medium controllers are provided. This contributes to device size reduction.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A digital camera comprising:
an image pickup unit which picks up an optical image;
a compression unit which compresses an image data picked up by the image pickup unit;
a first recording medium which stores the data compressed by the compression unit;
a second recording medium which stores the data compressed by the compression unit;
a communication controller which controls communication between one, which is selected, of the first recording medium and the second recording medium, and the compression unit;
a connection selector unit which selects one of the first recording medium and the second recording medium, and connects the selected recording medium to the communication controller;
a user interface; and
a control unit which controls the connection of the connection selector unit according to an instruction input through the user interface.

2. The digital camera according to claim 1, further comprising a semiconductor memory contained in the digital camera, wherein
when an instruction to dub predetermined data recorded in the first recording medium into the second recording medium is input through the user interface,
the control unit turns the connection selector unit to the first recording medium side, and reads out the predetermined data from the first recording medium through the communication controller and writes the read out data into the semiconductor memory,
and the control unit turns the connection selector unit to the second recording medium side, and reads out the predetermined data from the semiconductor memory, and writes the read out data into the second recording medium through the communication controller

3. A digital camera comprising:
an image pickup unit which picks up an optical image;
a compression unit which compresses an image data picked up by the image pickup unit;
an HDD which stores the data compressed by the compression unit;
a card slot to which a memory card for storing the data compressed by the compression unit is attached;
a communication controller which controls communication between one, which is selected, of the HDD and the memory card attached to the card slot, and the compression unit;
a connection selector unit which selects one of the HDD and the memory card attached to the card slot, and connects the selected recording medium to the communication controller;
a user interface; and
a control unit which controls the connection of the connection selector unit according to an instruction input through the user interface.

4. The digital camera according to claim 1, further comprising a semiconductor memory contained in the device, wherein
when an instruction to dub predetermined data recorded in one of the HDD and the memory card attached to the card slot into the other of the recording medium is input through the user interface,
the control unit turns the connection selector unit to one of the recording medium side, and reads out the predetermined data from the one recording medium through the communication controller and writes the read out data into the semiconductor memory,
and the control unit turns the connection selector unit to the other of the recording medium side, and reads out the predetermined data from the semiconductor memory, and writes the read out data into the other recording medium through the communication controller.
